(19) United States
(12) Patent Application Publication
(10) Pub. No.: US 2008/0121336 A1
(43) Pub. Date: May 29, 2008

(54) Method for forming a foamed product integral with trim cover assembly

(75) Inventor: Tsuyoshi Tabata, Akishima-shi (JP)

Correspondence Address: BROWDY AND NEIMARK, P.L.L.C.;624 NINTH STREET, NW, SUITE 300, WASHINGTON, DC, 20001-5303, US

(73) Assignee: Tachi-S Co., Ltd., Akishima-shi (JP)

(21) Appl. No.: 11/603,895

(22) Filed: Nov. 24, 2006

(51) Int. Cl. B29C 67/00

(52) U.S. Cl. 156/87

(57) ABSTRACT

Method for forming a foamed product integral with trim cover assembly having an unexposed or concealed portion which is to be unexposed or concealed by an external element. A gas exhaust area is defined in a particular portion of trim cover assembly which corresponds to that concealed or unexposed portion. A foaming die device used includes a local space area in the operative foaming space thereof, the local space area being adapted to accommodate such particular portion of trim cover assembly. An exhaust element is connected with the foaming die device in communication with the afore-said local space area, so that, after having injected a liquid foaming agent to an inside of the trim cover assembly and during foaming process, a whole of activated gas generated from the liquid foaming agent being cured is exhausted by the exhaust element from the trim cover assembly.

### BACKGROUND OF THE INVENTION

1. Field of the Invention

The present invention relates to a method by which a three-dimensional trim cover assembly is subjected to foaming, which basically consists in injecting a liquid foaming agent into an inside of such trim cover assembly and then curing the liquid foaming agent so as to fill a resultant foam padding in the trim cover unit, thereby forming a foamed product integral with the trim cover assembly, such as an armrest or an armrest with cup holder for instance. In particular, the invention is directed to a method of this kind which takes into account an activated gas generated during the foaming process.

2. Description of Prior Arts

For example, from the Japanese Laid-Open Patent Publication No. 2000-238568, a foaming method for forming a headrest is known. According thereto, a three-dimensional trim cover assembly, preformed in a generally cubic shape conforming to a given shape of headrest, with an injection hole formed in one lateral surface thereof, is subjected to foaming process. In this process, the trim cover assembly is placed in a predetermined die, and then, a liquid foaming agent is injected through such injection hole into the inside of the trim cover assembly. During foaming process, the liquid foaming agent is cured and transformed into an increased mass of foam padding filled in the trim cover assembly, so that a foamed product integral with the trim cover assembly is produced.

Hitherto, in the foaming process, particularly at the step of curing the liquid foaming agent into an increased mass of foam, it is known as a technical problem that an activated gas is generated therefrom and trapped in the resultant foam padding, thus forming a gas trapped area therein to cause deformation of the foam padding. As a result, the foam padding or the outer shape of final product can not be formed in a predetermined size and shape.

In general, to solve such problem, a layer of slab foam wadding is adhered to the inner surface of the trim cover element in order that the activated gas generated in the trim cover assembly during foaming will be absorbed by that slab foam wadding.

However, such conventional method inevitably requires attaching the slab foam wadding layer to the inner surface of trim cover element before the foaming process, which results in increased costs for providing such particular step and additional cost for forming the slab foam wadding itself.

Further, in the conventional method, during the foaming process, a certain amount of the liquid foaming agent being cured in the trim cover assembly is leaked out through an injection portion of the trim cover assembly, the injection portion being adapted to allow an injection nozzle to pass therethrough so that the liquid foaming agent is injected via the injection nozzle into the inside of the trim cover assembly. As a result thereof, the leaked liquid foaming agent is cured on the outer surface of trim cover assembly and left thereon as an objectionable point that can be viewed from the outside, which will undesirably impair the aesthetic appearance of a resultant foamed product.

### SUMMARY OF THE INVENTION

In view of the afore-stated drawbacks, it is a purpose of the present invention to provide an improved method for forming a foamed product integral with trim cover assembly, which insures to completely exhaust an activated gas from inside of trim cover assembly during foaming process and also conceal an objectionable point on a resultant foamed product, which has been created due to leakage of a liquid foaming agent from the trim cover assembly during the foaming process.

In order to achieve such purpose, in accordance with the present invention, there is basically provided a method for injecting and curing a liquid foaming agent in a three-dimensional trim cover assembly to thereby form a resultant-foam product integral with trim cover assembly, wherein the resultant foamed product integral with trim cover assembly includes a concealed or unexposed portion which is to be concealed or unexposed by an external element when a portion of the resultant foamed product integral with trim cover assembly, which corresponds to the concealed or unexposed portion, is mounted on or contacted with the external element,

the method including:
a first step of defining a gas exhaust area in a particular portion of the three-dimensional trim cover assembly which corresponds to the concealed or unexposed portion of the resultant foamed product integral with trim cover assembly;
a second step of defining an exhaust hole in the particular portion of the three-dimensional trim cover assembly;
a third step of providing a foaming die device which at least comprises: a first die having a die surface defined therein; and a second die having a die surface defined therein, such that the first and second dies are engageable with each other so as to provide an operative foaming space defined by the die surfaces respectively of the first and second dies, the operative foaming space substantially conforming to an outer shape of the three-dimensional trim cover assembly;
a fourth step of defining, in the operative foaming space to be provided by the foaming die device, a local space area for accommodating therein the particular portion of the three-dimensional trim cover assembly where the gas exhaust area is defined;
a fifth step of connecting a gas exhaust means with the foaming die device at a point corresponding to the local space area in the foaming die device so as to be in communication with the local space area through the exhaust hole defined in the particular portion of the three-dimensional trim cover assembly;
a sixth step of placing the three-dimensional trim cover assembly in the operative foaming space defined by the die surfaces respectively of the first and second dies;
a seventh step of injecting the liquid foaming agent into an inside of the three-dimensional trim cover assembly; and
an eighth step of curing the liquid foaming agent, while simultaneously exhausting an activated gas generated from the liquid foaming agent, via the exhaust means, from the gas exhaust area of the three-dimensional trim cover assembly, so that a foam padding is formed and filled in the three-dimensional trim cover assembly, thereby producing the resultant foam product integral with trim cover assembly, with none of the activated gas being present therein.

Other various features and advantages of the present invention will become apparent from reading of the description hereinafter, with reference to the annexed drawings.

### BRIEF DESCRIPTION OF THE DRAWINGS

FIG. 1 is a sectional view showing one exemplary mode of method for forming a foamed product integral with trim cover assembly in accordance with the present invention, which shows a foaming die device used and the step of injecting a liquid foaming agent into an inside of trim cover assembly placed in the foaming die device;

FIG. 2 is a sectional view of the foregoing one exemplary mode, which explanatorily shows a process where the injected liquid foaming agent is being cured and foamed, and simultaneously, an activated gas generated therefrom is exhausted therefrom to the outside;

FIG; 3 is a perspective view partly in section, which shows an armrest with cup holder as a resultant foamed product formed by the one exemplary mode of method;

FIG. 4 is a schematic perspective view of a foaming die device used in another exemplary mode of method for forming a foamed product integral with trim cover assembly in accordance with the present invention;

FIG. 5 is a sectional view of such another exemplary mode, which explanatorily shows a process where the injected liquid foaming agent is being cured and foamed in a trim cover assembly placed in the foaming die device, and simultaneously, an activated gas generated therefrom is exhausted therefrom to the outside; and

FIG. 6 is a partly broken perspective view showing an armrest as a resultant foamed product formed by the present mode of the present another exemplary mode of method.

### DETAILED DESCRIPTION OF PREFERRED EMBODIMENT OF THE INVENTION

Generically stated, in accordance with the present invention, a means for absorbing activated gas is simply provided in the above-described conventional method for forming a foamed product integral with a trim cover element, which uses a die and consists in injecting a liquid foaming agent into the inside of a trim cover assembly placed in the die and curing the liquid foaming agent into a mass of foam padding in the trim cover assembly.

The die and trim cover assembly used are not limitative, insofar as they serves the purpose of forming a foamed product integral with the trim cover assembly. As noted earlier, the term “foamed product integral with trim cover assembly” is a generic term which generically refers to a foam product formed integrally together with a three-dimensional trim cover assembly, which is typically formed by undergoing the known steps of: injecting a liquid foaming agent into the inside of the trim cover assembly preformed in a predetermined shape and placed in a given die means; and then curing the liquid foaming agent into an increased mass of foam material (e.g. foam padding) filled in the trim cover assembly. Examples of the resultant product formed thereby include an armrest, an armrest with a cup holder, a headrest, and so forth.

Hereinafter, the term, “foamed product integral with trim cover assembly”, and the term, “resultant foamed product integral with trim cover assembly”, shall be referred to as “foamed product” and “resultant foamed product”, respectively, for the sake of simplicity.

The present invention is based upon such conventional methods for forming the foam product and provides a simplified solution for effectively solving the previously stated problem that, during foaming process, an activated gas is generated and trapped in the trim cover assembly , and also, a liquid foaming agent is leaked through an injection hole of the trim cover assembly, which results in an objectionable portion being formed in a resultant foam product. In accordance with the present invention, generically stated, such solution is attained by:

(i) providing a gas exhaust means to a foaming die device, the gas exhaust means being operable for sucking an activated gas to be generated from a liquid foaming agent to be cured in the trim cover assembly placed in the foaming die device during a foaming process and exhausting such activated gas from the trim cover assembly;

(ii) defining a gas exhaust area in the trim cover assembly at a point corresponding to a concealed or unexposed local portion of a resultant foam product, wherein the concealed or unexposed local portion refers to a localized portion of the resultant foam product which is to be concealed or unexposed by an external element which for example includes: a local portion of seat which is to adjoin or contact that particular localized portion of resultant foam product; and an attachment to the seat, which is to overlie or contact that particular localized portion of resultant foam product; and

(iii) defining, in the afore-said foaming die device, a particular area to which is provided the afore-said gas exhaust means at a point corresponding to the afore-said particular portion of the trim cover assembly.

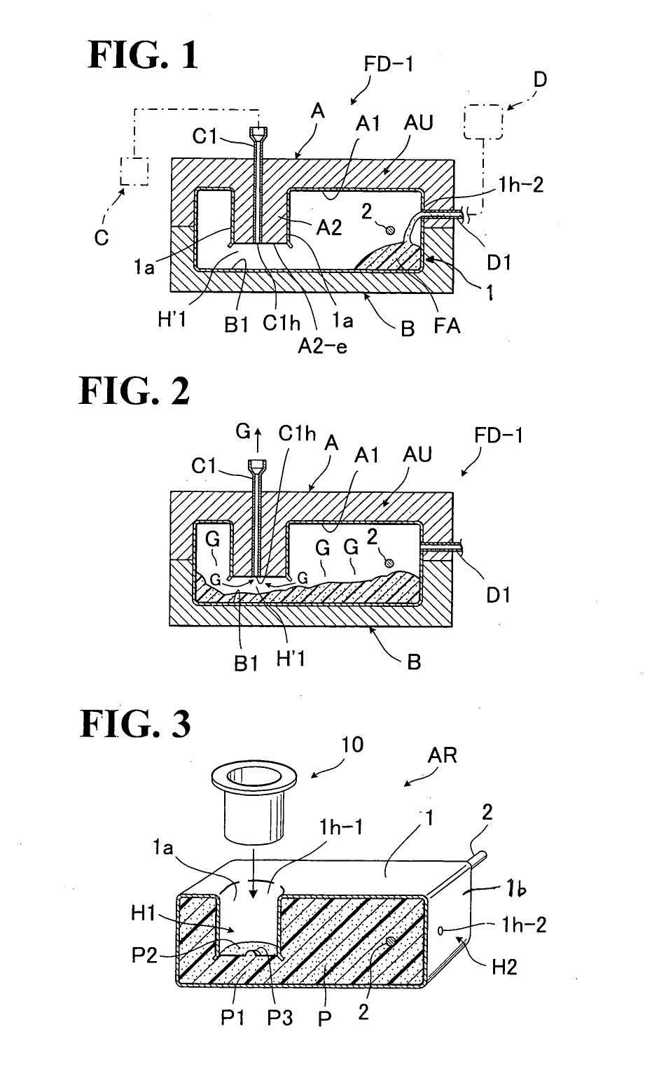

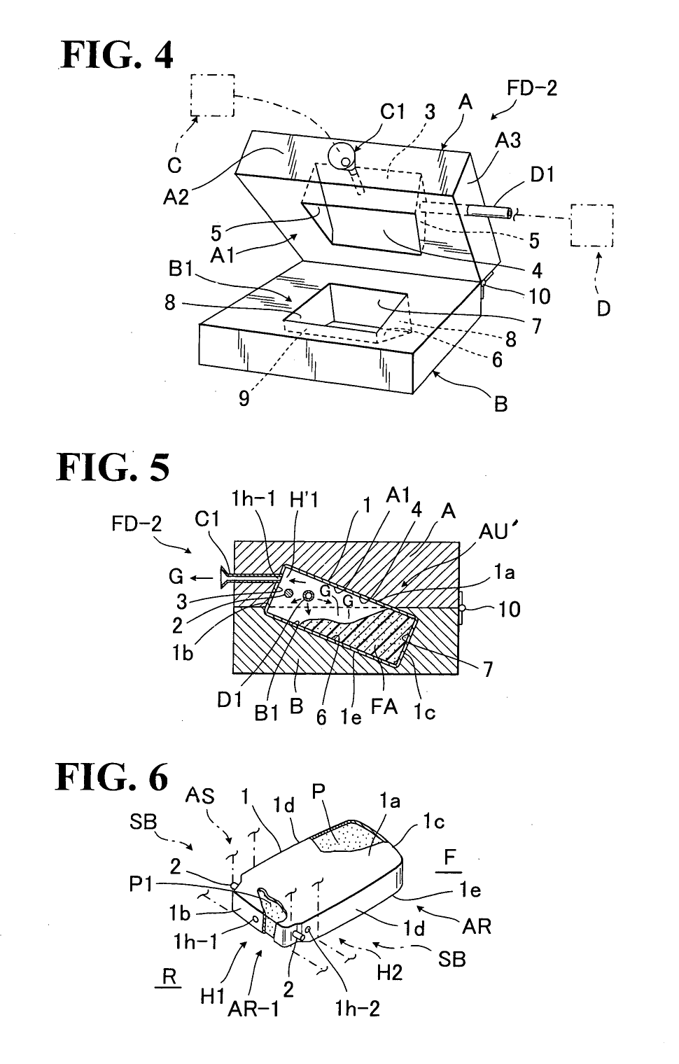

Hence, it should be first understood that FIGS. 1 to 3 shows one exemplary mode of the above-defined inventive concept of the present invention as applied to a conventional foaming method for forming an armrest with cup holder, and that FIGS. 4 to 6 shows another exemplary mode of the above-defined inventive concept of the invention as applied to a conventional foaming method for forming an ordinary foldable armrest. Again, those two embodiments are not limitative, and the inventive concept of the present invention is applicable to other methods for forming a foamed product integral with trim cover element within the scopes and gist of the present invention.

Referring now to FIGS. 1 to 3, a conventional foaming die device (FD-1) for forming an armrest with a cup holder is provided, which comprises: an upper die (A) having a columnar die portion (A2) for forming a hole in a resultant foamed product, which is adapted to receive a cup holder therein, as will be stated later; and a lower die (B). As is known, the upper and lower dies (A) and (B) have their respective predetermined recessed die surfaces (A1) and (B1) which are in aggregate substantially equal in size to the outer whole side of the trim cover assembly (1). As seen in FIG. 2, the columnar die portion (A2) is formed integrally on the recessed die surface (A1) of the upper die (A) so as to project outwardly therefrom.

Designation (D1) denotes an injection nozzle penetrated through the upper die (A), which is adapted for injecting a liquid foaming agent (FA) into the inside of the die element. This injection nozzle (D1) is connected and communicated with a liquid foaming agent supply device (D), as is known in the art.

As understandable from FIGS. 1 and 3, a three-dimensional trim cover assembly used in this embodiment is designated by (1) and preformed in a predetermined shape of armrest (in a hexahedron configuration), with a cylindrical cover section (1a) formed therein. As best seen from FIG. 3, the cylindrical cover section (1a) is defined in one surface of the trim cover assembly (1) so as to extend inwardly of that particular trim cover assembly, thus forming a portion for receiving a cup holder (10) therein as will be described later. It is noted here that the inner diameter of this cylindrical cover section (1a) is substantially equal to the outer diameter of the foregoing columnar die portion (A2).

Designation (2) denotes a known support shaft extending transversely through the trim cover assembly (1). Designation (1h-2) denotes an injection hole through which an injection nozzle (D1) is to be inserted as will be described, the injection hole (1h-2) being formed in one lateral surface (1b) of the trim cover assembly (1).

In the present embodiment, as the above-defined gas exhaust means, there is provided a long exhaust tube (C1). The above-defined gas exhaust area in trim cover assembly is embodied by a local space area in the trim cover assembly (1), which is defined right below the cylindrical cover section (1a) of trim cover assembly (1), and also, the above-defined particular area in foaming die device is embodied by a local space area in the foaming die device (FD-1), which is defined between an end surface (A2-e) of the columnar die portion (A2) of upper die (A) and the recessed die surface (B1) of lower die (B), when the upper die (A) is engaged on the lower die (B) to provide a closed state of the die device. (FD-1). Those two local space areas associated respectively with the trim cover assembly (1) and foaming die device (FD-1) are commonly designated by (H′1).

Specifically, as shown in FIG. 1, as stated above, when the upper die (A) is engaged on the lower die (B) to provide a closed state of the foaming die device (FD-1), the local space area (at H′1) is defined between the end surface (A2-e) of the columnar die portion (A2) of upper die (A) and the recessed die surface (B1) of lower die (B). That local space area (H′1) is a local die region for forming a localized area (P1) of resultant foam padding (P) at which a flat bottom surface (P2) is defined in the cylindrical bore (1h-1) adapted for receiving a cup holder (10) therein. This means that the flat bottom surface (P1) corresponds to an unexposed local portion to be unexposed or hidden by the cup holder (10), and therefore, the afore-said local space area (at H′1) constitutes the above-defined particular area of the foaming die device (FD-1) to which the afore-said long exhaust tube (C1) is to be provided. Such local space area (at H′1) is also adapted for forming the unexposed local portion (H1) of resultant armrest (AR) (see FIG. 3). Accordingly, in this particular embodiment, it is essential to locate the long exhaust tube (C1) at a point adjacent to such local space area (H′1). Namely, as shown in FIG. 1, the exhaust tube (C1) is provided in the columnar die portion (A2) such that a free end (C1h) of the former is disposed in or flush with the end surface (A2-e) of the latter.

Now, a specific description will be made of an operation for effecting the above-described method.

At first, as understandable from FIG. 1 in conjunction with FIG. 3, a basic armrest unit (AU), typically comprising the three-dimensional trim cover assembly (1) and a support shaft (2), is provided, which is to undergo a foaming process to be described hereinafter.

As shown in FIG. 1, such basic armrest unit (AU) is placed between the upper and lower dies (A) (B), such that the columnar die portion (A2) of the upper die (A) is fit inserted in the cylindrical cover potion (1a) of trim cover assembly (1), while other whole surfaces of the trim cover assembly (1) are fit contacted with the recessed die surfaces (A1) (B1) of the two dies (A) (B). Then, as shown, the injection nozzle (D1) is inserted through the injection hole (1h-2) of the trim cover assembly (1) and a liquid foaming agent (P1) is injected into the inside of the trim cover assembly (1) through the injection nozzle (D1) by operation of liquid foaming agent supply device (D).

Thereafter, as shown in FIG. 2, the injected liquid foaming agent (P1) is cured and foamed into an increased mass within the trim cover assembly (1). At this point, as indicted by (G), a certain volume of activated gas is generated from the thus-treated foaming agent (P1) At the same time, the gas exhaust device (C) is operated to suction a whole volume of the activated gas (G) through the exhaust tube (C1), so that, as indicated by the arrow, the gas (G) is exhausted from the trim cover assembly (1) to the outside of the foaming die device (FD-1). Finally, the liquid foaming agent (P1) is transformed into a mass of foam padding (P) filled in the trim cover assembly (1), thereby producing an armrest body (AR) as shown in FIG. 3.

As in the FIG. 3, the resultant armrest body (AR) has a hole (1h-1) and a cup holder (10) is fitted in that hole (1h-1) as indicated by the arrow, whereupon an armrest with cup holder is produced.

According to the present embodiment, it is appreciated that (i) a whole of the gas (G) generated during the foaming process naturally gathers to a point beneath the end surface (A2-e) of columnar die portion (A2) and therefore, if a certain amount of the gas (G) is trapped and remains unremoved between that particular end surface (A2-e) and a surface of the resultant foam padding (P), it is easily possible to let out such certain amount of residual gas by simply removing the columnar die portion from the hole (1h-1), thereby completely solving a problem with the gas trapping, and (ii) the bottom (at P2) of the hole (1h-1) forms the above-defined unexposed local portion (H1) of resultant foamed product (i.e. the armrest (AM), and thus, that particular unexposed local portion (H1)) is unexposed and overlaid by the cup holder (10) fitted in the hole (1h-1), thereby completely concealing an objectionable protrudent portion (P3) which has been formed on the bottom surface (P2) in the hole (1h-1) due to the foregoing gas suction through the exhaust tube (C1) during the foaming process. It is seen that the cup holder (10) itself is therefore the above-defined external element or the attachment to the armrest (AR) in particular. Further, as can be seen in FIG. 3, the injection hole (1h-2) is formed in a lateral surface of the armrest, adjacent to which the support shaft (2) is located. This localized area is to be concealed or unexposed by adjoining local portions of a seat, when the armrest (AR) is mounted to the seat. In other words, while not shown in FIG. 3, but, referring to FIG. 6, it is to be seen that such localized area where the injection hole (1h-2) lies corresponds to the backward portion (AR-1) of resultant armrest (AR) to be described in a second embodiment, which is to be concealed by a seat back (SB) of a seat (S) which is the external element defined above. Hence, such localized area forms another unexposed or concealed local portion (H2) of the armrest.

Reference is now made to FIGS. 4 to 6 which are illustrative of the previously stated exemplary mode of the present invention as applied to a conventional foaming method for forming an ordinary foldable armrest.

In this embodiment, as understandable from FIG. 5 and 6, a three-dimensional trim cover, assembly used in this embodiment is designated by (1) and preformed in a predetermined shape of armrest (in a hexahedron configuration), as is known. As best seen from FIG. 6, the trim cover assembly (1) has: a first cover section (1a) on which a user's arm is to rest; a second cover section (1b) which is to face to a backward side (R) of a seat (not shown) when a resultant armrest is in a horizontally extending use position, while being to face to a lower side when the resultant armrest is in an upright non-use position, as will be describe later; a third cover section (1c) which is to face to a forward side (F) of the seat when the resultant armrest is in the horizontally extending use position as will be describe later; a pair of lateral cover sections (1d) (1d); and a reverse cover section (1e) opposite to that first cover section (1a). Designation (2) denotes a known support shaft, which, as can be seen in FIG. 6, extends through and transversely of an end portion of such trim cover assembly at which the second cover portion (1b) lies.

A foaming die device (FD-2) used in this embodiment is basically formed by a lower die (B) and an upper die (A) movably connected via hinge (10) with the lower die (B), as is known in the art.

In accordance with the present invention, as the above-defined gas exhaust means, there are provided an exhaust tube (C1) and two recessed die surfaces (A1) (B1) which are formed aslant in the two respective upper and lower dies (A) (B) in such a manner as shown in FIG. 1.

Specifically, in the upper die (A), the recessed die surface (A1) may be formed by a vertical die surface region (3), a sloped upper die surface region (4) and a pair of triangular lateral die surface regions (5) (5) so as to provide a predetermined three-dimensional space for accommodating therein about one-third portion of the trim cover assembly (1) which forms a backward portion of the trim cover assembly (1), wherein such about one-third portion of trim cover assembly (1) may, as shown in FIG. 5 for example, comprise: a substantially whole area of the backward lateral cover section (1b); and the corresponding local areas respectively of the first cover section (1a) and two lateral cover sections (1d) (1d). It is noted that such backward portion of trim cover assembly (1) is to face to the backward side (R) when a resultant armrest (at AR) integral with the trim cover assembly (1) is mounted on the seat (S), as understandable from FIG. 6.

On the other hand, in the lower die (B), the recessed die surface (B1) may be formed by a sloped bottom die surface region (6), a sloped die surface region (7), and a pair of trapezoidal lateral die surface regions (8) (8) so as to provide a predetermined three-dimensional space for accommodating therein about two-third portion of the trim cover assembly (1) which forms a forward portion of the trim cover assembly (1), wherein such about two-third portion of the trim cover assembly (1) may, as shown in FIG. 5 for example, comprise: a whole area of the forward lateral cover section (1c); a whole area of the reverse cover section (1e); and the corresponding local areas respectively of the two lateral cover sections (1d) (1d). It is noted that such forward portion of trim cover assembly (1) is to face to the forward side (F) when a resultant armrest (at AR) integral with the trim cover assembly (1) is mounted on a seat (S), as understandable from FIG. 6.

The above-defined gas exhaust area in trim cover assembly is embodied by a local pace area of the trim cover assembly (1) which corresponds to the afore-said about one-third portion of the trim cover assembly (1) or the backward portion of the trim cover assembly (1). Also, the above-defined particular area in foaming die device is embodied by a local spaced area in the recessed die surface (A1) of the upper die (A) of the foaming die device (FD-2). Those two local space areas associated respectively with the trim cover assembly (1) and foaming die device (FD-2) are commonly designated by (H′1).

Specifically, as shown in FIGS. 4 and 5, such area (H′1) is an upper space area in the recessed die surface (A1) of upper die (A), wherein such upper space area is a space area defined by the vertical die surface region (3) and two upper localized areas respectively of the two lateral die surfaces regions (5). That particular upper space area (H′1) is a local die region for forming a backward end portion (P1) (see FIG. 6) of a resultant foam padding (P). As understandable from FIG. 6, as will be specified, a backward end portion (AR-1) of resultant armrest (AR) is to be formed by such backward end portion (P1) of foam padding (P) as well as by corresponding five backward localized cover sections of the trim cover assembly (1). As also understandable from the FIG. 6, that backward end portion (AR-1) of resultant armrest (AR) is to be concealed by a seat back (SB). This means that the afore-said backward end portion (P1) of resultant foaming padding (P) as well as the afore-said backward end portion of trim cover assembly (1) which covers that particular foam padding backward end portion (P1) correspond to the previously defined localized portion of resultant foamed product which is to be concealed by a local portion of seat. Accordingly, in the present embodiment, it is essential to locate the exhaust tube (C1) and injection nozzle (D1) at proper points in the upper die (A1) which correspond to the afore-stated upper space area (H′1) in the recessed die surface (A1) of upper die (A). Namely, as best shown in FIG. 4, the exhaust tube (C1) is provided in one lateral portion (at A2) of the upper die (A) which corresponds to the vertical die surface region (3), so as to extend therethrough to the upper space area (H′1) in the recessed die surface (A1) in communication therewith. Further, as seen in FIGS. 4 and 5, the injection nozzle (D1) is provided in another lateral portion (at A3) of the upper die (A) which corresponds to one lateral die surface region (4), so as to extend therethrough to the foregoing upper space area (H′1) in communication therewith. As indicated by the one-dot chain lines in FIG. 4, the exhaust tube (1) and injection nozzle (D1) are respectively connected and communicated with a gas exhaust device (C) and a liquid foaming agent supply device (D).

With the foregoing in view, as understandable from FIG. 6, an exhaust hole (1h-1) is formed in the second cover section (1b) of trim cover assembly (1) which corresponds to the upper space area (H′1) of upper die (A), whereas an injection hole (1h-2) is formed in a localized region of the right-side lateral cover section (1d) which lies near to the second cover section (1b) and corresponds to the upper space area (H′1).

A specific description will be made of an operation for effecting the above-described mode of method. At first, as understandable from FIGS. 5 and 6, a basic headrest unit (AU′) typically comprising the three-dimensional trim cover assembly (1) and support shaft (2) is provided, which is to undergo a foaming process to be described hereinafter.

As understandable from FIG. 5, such basic headrest unit (AU′) is placed aslant in the recessed die surface (B1) of lower die (B), such that about two-third portion of trim cover assembly (1) is received in that recessed die surface (B1) so as to be inclined downwards to the bottom of lower die (B), while about remaining one-third portion of trim cover assembly (1) is exposed from lower die (B), as can readily be understood from the FIG. 5. Then, the upper die (A) is placed on the lower die (B) in order that the recessed die surface (A1) thereof overlays such one-third portion of trim cover assembly (1) in conformity therewith, and that a free end of the exhaust tube (C1) is aligned with and inserted in the exhaust hole (1h-1) of trim cover assembly (1), while a free end of the injection nozzle (D1) is inserted into the injection hole (1h-2) of trim cover assembly (1), as understandable from FIGS. 5 and 6. In that way, a whole of the trim cover assembly (1) is placed in an operative foaming space defined by the two recessed die surfaces (A1) (B1).

Then, a certain amount of liquid foaming agent (P1) is injected into the inside of the trim cover assembly (1) through the injection. nozzle (D1) by operation of liquid foaming agent supply device (D).

Thereafter, the injected liquid foaming agent (P1) is cured and foamed into an increased mass within the trim cover assembly (1). At this point, as indicted by (G), a certain volume of activated gas is generated from the thus-treated foaming agent (P1). At the same time, the gas exhaust device (C) is operated. In this respect, it is appreciated that, due to the trim cover assembly (1) being inclined upwardly in the die (FD-2) as in FIG. 5 the generated activated gas (G) naturally rises toward the one-third or upward end portion of the trim cover assembly (1) at which the exhaust tube (C1) is located, and therefore, a whole volume of the gas (G) is efficiently sucked into the exhaust tube (C1) and exhausted, as indicated by the arrow, from the trim cover assembly (1) to the outside of the die (FD-2). During the foaming process, the liquid foaming agent (P1) is transformed into an increased mass of foamed product within the trim cover assembly (1), and thus, it is also appreciated that, by the reason hat such increased mass of foamed product is being swollen upwardly in the trim cover assembly (1), a whole of the activated gas (G) is uniformly pressed upwardly toward that one-third portion of the trim cover assembly (1), and eventually, when the mass of foamed product is filled in the trim cover assembly (1) as a foam padding (P), the gas (G) is completely exhausted through the exhaust tube (C1) to the outside of the die (FD-2).

FIG. 6 shows a resultant armrest (AR) formed in the above-described foaming method. As shown, it is therefore appreciated that the previously defined concealed local portion of resultant foamed product corresponds to one end portion (AR-1) of the thus-formed armrest (AR), wherein, as described above, in that one end portion (AR-1), the activated gas (G) has been exhausted and also the liquid foaming agent has been injected, and further, there lie the second cover section (1b) and a localized region of the right-side lateral cover section (1d) which adjoins that second cover section (1b). This is because, as indicated by the two-dot chain lines in FIG. 6, when the armrest (AR) is mounted on a seat having a seat back (SB), such one end portion (AR-1) of the armrest (AR) is situated in the seat back (SB) or in an armrest storage area (AS) defined in the seat back (SB), thereby being invisible from the outside, whereupon it is to be seen that that particular one end portion (AR-1) constitutes: one concealed local portion (H1) for concealing the exhaust hole (1h-1); and another concealed local portion (H2) for concealing the injection hole (1h-2). Namely, the exhaust hole (1h-1) and injection hole (1h-2), which are actually objectionable and impairs outer aesthetic appearance of the armrest (AR), are both completely concealed in the seat back (SB). It is seen here that such seat back (SB) is the external element defined previously.

While having described the present invention thus far, it should be understood that the invention is not limited to the illustrated embodiments, but any modification, replacement and addition may be methodologically applied thereto without departing from the scopes of the appended claims.

What is claimed is:

1. Method for injecting and curing a liquid foaming agent in a three-dimensional trim cover assembly to thereby form a resultant foam product integral with trim cover assembly, wherein said resultant foamed product integral with trim cover assembly includes a concealed or unexposed portion which is to be concealed or unexposed by an external element when a portion of said resultant foamed product integral with trim cover assembly, which corresponds to said concealed or unexposed portion, is mounted on or contacted with said external element,
said method including:
a first step of defining a gas exhaust area in a particular portion of said three-dimensional trim cover assembly which corresponds to said concealed or unexposed portion of said resultant foamed product integral with trim cover assembly;
a second step of defining an exhaust hole in said particular portion of said three-dimensional trim cover assembly;
a third step of providing a foaming die device which at least comprises: a first die having a die surface defined therein; and a second die having a die surface defined therein, such that said first and second dies are engageable with each other so as to provide an operative foaming space defined by said die surfaces respectively of the first and second dies, said operative foaming space substantially conforming to an outer shape of said three-dimensional trim cover assembly;
a fourth step of defining, in said operative foaming space to be provided by said foaming die device, a local space area for accommodating therein said particular portion of said three-dimensional trim cover assembly where said gas area is defined;
a fifth step of connecting a gas exhaust means with said foaming die device at a point corresponding to said local space area in the foaming die device so as to be in communication with the local space area through said exhaust hole defined in said particular portion of said three-dimensional trim cover assembly;
a sixth step of placing said three-dimensional trim cover assembly in said operative foaming space defined by said die surfaces respectively of said firth and second dies;
a seventh step of injecting said liquid foaming agent into an inside of said three-dimensional trim cover assembly; and
an eighth step of curing said liquid foaming agent, while simultaneously exhausting an activated gas generated from the liquid foaming agent, via said exhaust means, from said gas exhaust area of said three-dimensional trim cover assembly, so that a foam padding is formed and filled in the three-dimensional trim cover assembly, thereby producing said resultant foam product integral with trim cover assembly, with none of said activated gas being present therein.

2. The method as claimed in claim 1, wherein said first die is positioned above said second die and movable for engagement upon the second die so as to provide said operative foaming space, with said die surface of said first die being disposed above said die surface of said second die, wherein said three-dimensional trim cover assembly has: one portion corresponding to said particular portion thereof; and another portion opposite to said one portion, whereupon said gas exhaust area is defined in said one portion of the three-dimensional trim cover assembly, wherein said local space area at said third step is defined in said die surface of said first die, whereupon said die surface of said first die is adapted to accommodate therein said one portion of the three-dimensional trim cover assembly, while said die surface of said second die is adapted to accommodate therein said another portion of the three-dimensional trim cover assembly, and wherein said gas exhaust means is connected with said first die so as to be in communication with said local space area in said die surface of said first die through said exhaust hole of said three-dimensional trim cover assembly.

3. The method as claimed in claim 1, wherein said resultant foamed product integral with trim cover assembly is an armrest with cup holder, wherein said thee-dimensional trim cover assembly has an opening area formed in said particular portion thereof at a point corresponding to said gas exhaust area, said opening area corresponding to said exhaust hole and being adapted to receive said cup holder therein, wherein said first die has a die portion defined in said local space area, said die portion being adapted for forming a recessed portion in said foam padding, said recessed portion being substantially equal in size to said opening area of said three-dimensional trim cover assembly and being adapted to receive said cup holder therein, wherein said gas exhaust means includes an exhaust tube extending through said die portion of said first die so as to be in communication with said operative foaming space to be provided by said foaming die device, wherein, at said sixth step, prior to placing said three-dimensional trim cover assembly in said operative foaming space defined by said die surfaces respectively of said first and second dies, said die portion of said first die is inserted in said opening area of said three-dimensional trim cover assembly, and wherein, at said eighth step, by means of said die portion, said recessed portion is formed in said foam padding together with said opening area of said three-dimensional trim cover assembly, whereby an armrest is produced, which has a cup holder receiving portion defined therein in correspondence with said recessed portion and said opening area, and finally, a cup holder is fitted in said cup holder receiving portion, whereupon said cup holder receiving portion corresponds to said concealed or unexposed portion and said cup holder corresponds to said external element.
